(19) United States
(12) Patent Application Publication
(10) Pub. No.: US 2026/0201922 A1
(43) Pub. Date: Jul. 16, 2026

(54) MULTIPLE-PART MODULAR SHAFT

(71) Applicant: Air Squared, LLC, Thornton, CO (US)

(72) Inventors: Nathan D. Nicholas, Thornton, CO (US); John P.D. Wilson, Lakewood, CO (US)

(21) Appl. No.: 19/448,938

(22) Filed: Jan. 14, 2026

Related U.S. Application Data
(60) Provisional application No. 63/745,144, filed on Jan. 14, 2025.

(51) Int. Cl. F16C 3/12

(52) U.S. Cl. CPC F16C 3/12

(57) ABSTRACT

A multiple-part modular shaft includes a main shaft having a longitudinal axis extending along a length of the shaft and that defines a rotational center of the main shaft. The main shaft includes a modular interconnection interface including a rotational alignment feature at one side of the shaft that is rotationally fixed relative to the longitudinal axis. The multiple-part modular shaft includes an eccentric shaft having a first body portion and a second body portion. The first body portion is connected to the second body portion and the second body portion is eccentrically offset from the first body portion by a first offset distance. The eccentric shaft includes a mating interface and locking feature that connects with the rotational alignment feature and rotationally fixes the eccentric shaft to the main shaft relative to the longitudinal axis when the eccentric shaft is attached to the main shaft in an assembled state.

### CROSS-REFERENCE TO RELATED APPLICATIONS

The present application claims the benefit of and priority, under 35 U.S.C. § 119(e), to U.S. Provisional Application Serial No. 63/745,144, filed on January 14, 2025, entitled “MULTIPLE-PART MODULAR SHAFT,” the entire disclosure of which is hereby incorporated herein by reference, in its entirety, for all that it teaches and for all purposes.

### BACKGROUND

The present disclosure relates to driveshafts, and more particularly to a multiple-part modular crankshaft with an interchangeable eccentric journal.

Scroll devices, such as scroll compressors and expanders, typically use a crankshaft to drive an orbiting scroll eccentrically relative to a fixed scroll, for example, to compress or expand a working fluid. To provide the eccentric rotation of the orbiting scroll, the crankshaft includes a drive portion and an eccentric portion that is axially offset from the drive portion. This axial offset defines an eccentricity between the drive portion and the eccentric portion. The orbiting scroll is attached to the eccentric portion of the crankshaft and the drive portion of the crankshaft is rotated by a motor or other source of rotational energy. As the motor, or other source of rotational energy, rotates the drive portion of the crankshaft, the eccentric portion of the crankshaft causes the orbiting scroll to rotate eccentrically relative to the fixed scroll.

In general, these crankshafts are machined (e.g., turned via a lathe, etc.) from a single bar of material, or billet. Once an offset distance between an axis of the eccentric portion of the crankshaft and an axis of the drive portion of the crankshaft is determined, the crankshaft can be machined including the defined eccentricity. After machining the crankshaft, the eccentricity cannot be changed.

### BRIEF SUMMARY

Machining crankshafts from a single bar of material poses a number of problems for a manufacturer and an integrator. For instance, in order to machine a drive portion of the crank shaft and an eccentric portion of the crankshaft, the single bar of material must be selected from an oversized bar of material (e.g., sized as having an outermost diameter equal to the outermost dimension measured from the axis of the drive shaft to the outermost surface of the eccentric portion of the crankshaft) prior to machining. This oversized bar of material requires extensive machining time (and excess waste) to remove material when making the eccentric portion and the drive portion of the crankshaft.

In addition, when assembling a crankshaft to suit a particular scroll device arrangement, the eccentricity of the crankshaft is dependent on the orbiting scroll and fixed scroll dimensions and tolerances. Variations in these dimensions and tolerances may require a crankshaft to have a bespoke, or custom-defined, axial offset (e.g., eccentricity) to suit a particular scroll arrangement. In these cases, a new crankshaft may need to be manufactured, or an existing crankshaft may need to be reworked (e.g., by further machining, etc.) to work with a scroll arrangement. As can be appreciated, a scroll device manufacturer may be required to stock multiple crankshafts (having different fixed eccentricities between the eccentric portion and the drive portion) in order to account for the variability in dimensioning and tolerancing of orbiting and fixed scrolls.

It is with respect to the above issues and other problems that the embodiments presented herein were contemplated.

The present disclosure provides a multiple-component modular shaft, or crankshaft, that is capable of being manufactured in two separate parts and later joined together to form a crankshaft having a desired eccentricity. The multiple-component modular shaft may include a drive portion (e.g., a main shaft) with a modular interconnection interface and a rotational alignment feature. A separate eccentric portion (e.g., an eccentric shaft) may be separately manufactured to have a set eccentricity. The eccentric shaft may include a mating interface that joins with the modular interconnection interface of the main shaft and is rotationally keyed, or fixed, with the main shaft via the rotational alignment feature.

Among other things, the multiple-component modular shaft allows individual components of the crankshaft to be manufactured separately and efficiently. Although the dimensions of the main shaft may not change from shaft to shaft, the eccentric shafts can be manufactured having different axial offsets. This approach allows a manufacturer to select materials that are sized to the approximate finished size of each portion of the crankshaft rather than requiring an oversized bar of material be used to machine both portions of the crankshaft together. Additionally or alternatively, a scroll device manufacturer or integrator may maintain a plurality of main shafts in stock (since the dimensions should not require any changes) and then, during assembly of the scroll device, select an eccentric shaft having the desired eccentricity for the scroll arrangement. Should the dimensions or tolerances of the scroll arrangement require a different eccentricity, the eccentric shaft may be removed and replaced with another eccentric shaft having the different eccentricity (e.g., without replacing the main shaft). As can be appreciated, there is an unmet need for crankshafts that are convenient to assemble and dissemble and that are economical while enabling a change in eccentricity of the crankshaft.

At least one embodiment of the present disclosure includes a crankshaft with two or more separatable shafts including at least one main shaft and at least one eccentric shaft. The main shaft comprises a longitudinal axis defining a rotational center of the main shaft, and a modular interconnection interface arranged at one end of the main shaft. The eccentric shaft comprises a mating interface that can operatively connect to and engage with the modular interconnection interface. When in an assembled state, the eccentric shaft is fixed to the main shaft relative to the longitudinal axis and is rotatable around the longitudinal axis with an eccentric journal.

Among other things, the embodiments described herein provide manufacturers, integrators, assembly technicians, and/or end users with the ability to quickly and easily assemble and disassemble crankshafts with a desired eccentricity between an eccentric portion and a drive portion thereof. To aid in providing this quick and easy assembly, at least one embodiment of the present disclosure includes a crankshaft with a rotational alignment feature. The rotational alignment feature may include a doweled interconnection, a keyed interface, and/or some other locking arrangement (e.g., tab-in-slot, pin-in-slot, etc.) that is configured to rotationally fix, or lock, the eccentric shaft relative to the main shaft (when the eccentric shaft relative is mated with and attached to the main shaft). In one embodiment, the rotational alignment feature may include a pair of dowel holes formed in the main shaft and a corresponding pair of dowel holes formed in the eccentric shaft. In this example, a first pair of dowel holes may extend from the modular interconnection interface side of the main shaft into the body of the main shaft (e.g., in a direction toward an opposing end of the main shaft). The dowel holes of the first pair of dowel holes may be arranged at different sides of the longitudinal axis of the main shaft. Continuing this example, a second pair of dowel holes may extend from the mating interface of the eccentric shaft into a body of the eccentric shaft (e.g., in a direction toward a first protrusion of the eccentric shaft). The second pair of dowel holes may comprise an arrangement, dimension, and/or spacing that matches the first pair of dowel holes in the main shaft). In some embodiments, the second pair of dowel holes may be arranged at different sides of a longitudinal axis of the eccentric shaft. To lock the eccentric shaft to the main shaft, a user, such as an assembly technician or manufacturer, may mate a pair of dowel pins with the first pair of dowel pins and the second pair of dowel pins. Once mated, the eccentric shaft may be joined with the main shaft such that the dowel pins engage with the first pair of dowel holes and the second pair of dowel holes. In some embodiments, a first dowel pin may be inserted into a first dowel hole of the first pair of dowel holes (in the main shaft) and a second dowel pin may be inserted into a second dowel hole of the second pair of dowel holes (e.g., in the eccentric shaft). In this example, the inserted first dowel pin may be aligned with a first hole of the second pair of dowel holes and the inserted second dowel pin may be aligned with the second hole of the first pair of dowel holes. Once aligned, the eccentric shaft and main shaft may be moved axially toward one another until the eccentric shaft and the main shaft are connected.

To further secure the eccentric shaft to the main shaft, embodiments herein disclose a connecting structure arranged on both the main shaft and the eccentric shaft. For example, the main shaft and the eccentric shaft may be attached together by a fastener (e.g., screw, bolt, rivet, pin, etc.) In one embodiment, the main shaft may include a threaded hole and the eccentric shaft may include a clearance hole, a clearance hole and counterbore, a clearance hole and countersink, and/or the like. In some embodiments, the eccentric shaft may include a threaded hole and the main shaft may include a clearance hole, a clearance hole and counterbore, a clearance hole and countersink, and/or the like. In any event, a user can quickly and easily secure, or connect, the eccentric shaft to the main shaft by tightening a fastener that is mated with the threaded hole.

Another aspect of the present disclosure is the quick and easy exchange and/or replacement of the eccentric shaft with one or more eccentric shafts having different offset distances. This quick and easy exchange offers the ability to change the eccentricity of a crankshaft without disassembling the entire scroll device, reworking the existing eccentricity of a single-piece crankshaft, or manufacturing and/or installing a completely new crankshaft. At least some benefits of the combination of features described herein include, but are in no way limited to, providing a more economical manufacturing process, a more environmentally friendly manufacturing process (e.g., reducing machining waste), reductions in inventory costs and associated part numbers, decreased assembly and/or maintenance times, and improved performance for scroll devices having tolerance variations. In some embodiments the present disclosure provides a multiple-part modular shaft comprising a main shaft that is compatible with a plurality of eccentric shafts having any number of (different) eccentric offset distances. The eccentric shafts herein, when connected to the main shaft, share a same longitudinal axis with the main shafts but have a different eccentric journal due to the different eccentric offset distances configured in each eccentric shaft.

The term “scroll device” as used herein may refer to scroll compressors, scroll vacuum pumps, and similar mechanical devices. The term “scroll device” as used herein may also encompasses scroll expanders, with the understanding that scroll expanders absorb heat rather than generating heat, such that the various aspects and elements described herein for cooling scroll devices other than scroll expanders may be used for heating scroll expanders (e.g., using warm liquid).

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages are described herein and will be apparent to those skilled in the art upon consideration of the following Detailed Description and in view of the figures.

### BRIEF DESCRIPTION OF THE SEVERAL VIEWS OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1A shows a perspective view of a multiple-part modular crankshaft in accordance with embodiments of the present disclosure;

FIG. 1B shows an exploded perspective view of the main shaft of the multiple-part modular crankshaft shown in FIG. 1A;

FIG. 1C shows a first section view of the main shaft of the multiple-part modular crankshaft shown in FIG. 1A taken through a center of the main shaft;

FIG. 1D shows a second section view of the main shaft of the multiple-part modular crankshaft shown in FIG. 1A taken through a center of the main shaft;

FIG. 2A shows a perspective view of the main shaft of the multiple-part modular crankshaft in accordance with embodiments of the present disclosure;

FIG. 2B shows a front elevation view of the main shaft of the multiple-part modular crankshaft in accordance with embodiments of the present disclosure;

FIG. 2C shows a rear elevation view of the main shaft of the multiple-part modular crankshaft in accordance with embodiments of the present disclosure;

FIG. 3A shows a perspective view of the eccentric shaft of the multiple-part modular crankshaft in accordance with embodiments of the present disclosure;

FIG. 3B shows a front elevation view of the eccentric shaft of the multiple-part modular crankshaft in accordance with embodiments of the present disclosure;

FIG. 3C shows a rear elevation view of the eccentric shaft of the multiple-part modular crankshaft in accordance with embodiments of the present disclosure;

FIG. 4A shows a schematic front view of eccentrically arranged shafts of the multiple-part modular crankshaft with a first off-center distance in accordance with embodiments of the present disclosure; and

FIG. 4B shows a schematic front view of eccentrically arranged shafts of the multiple-part modular crankshaft with a second off-center distance in accordance with embodiments of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

Various aspects of the present disclosure will be described herein with reference to drawings that may be schematic illustrations of idealized configurations.

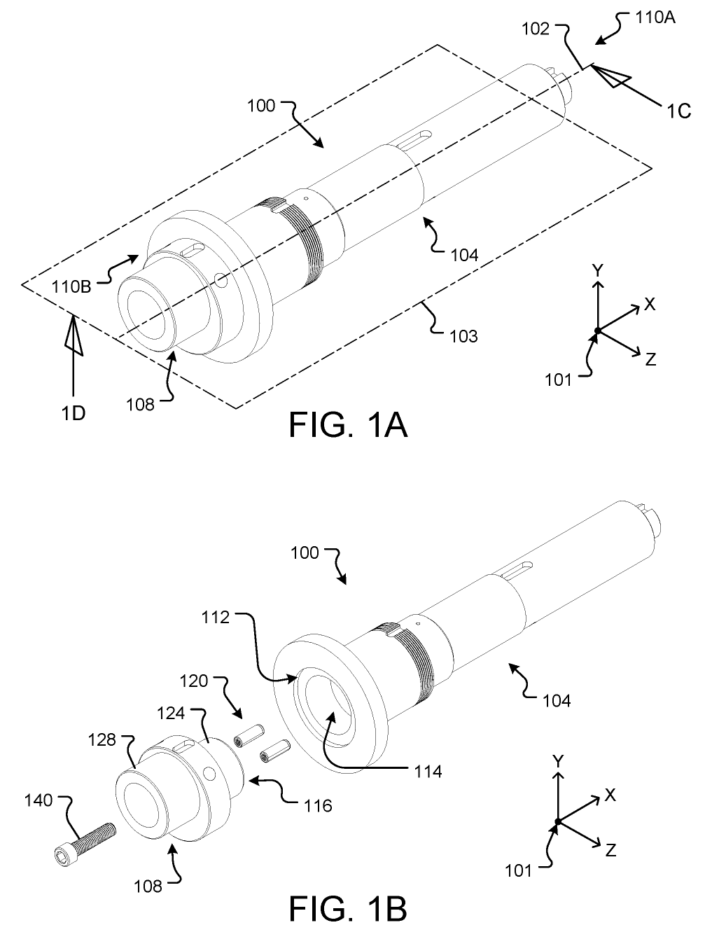

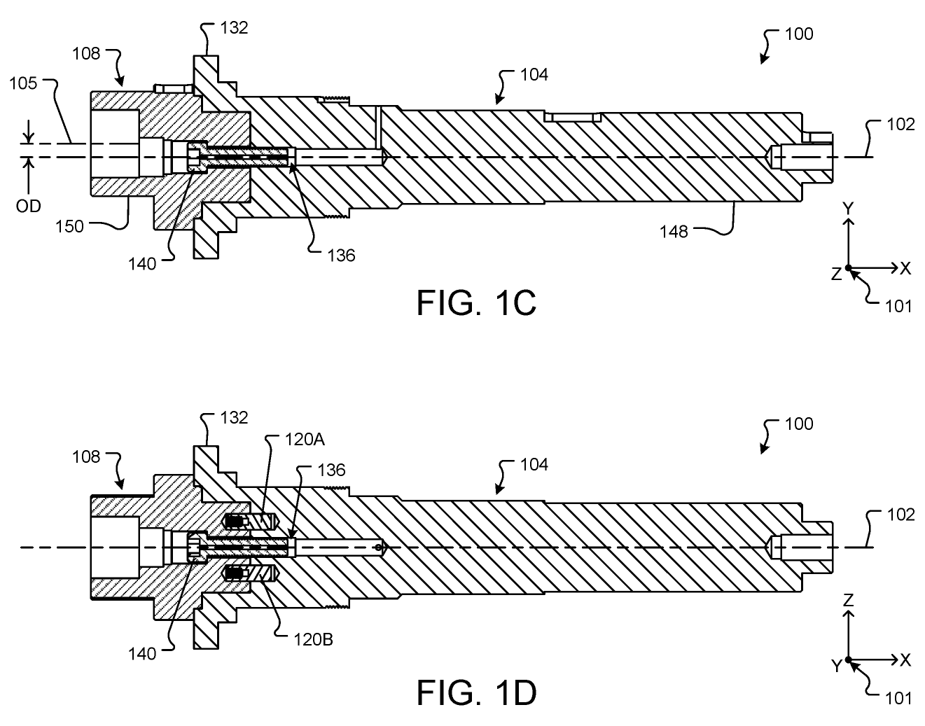

Referring initially to FIGS. 1A-1D, a multiple-part modular crankshaft 100 is shown in accordance with embodiments of the present disclosure. The multiple-part modular crankshaft 100 includes a main shaft 104 and an eccentric shaft 108. In one example, the eccentric shaft 108 may be releasably fixed to the main shaft 104 (e.g., by way of one or more fasteners, etc.). In some examples, when the eccentric shaft 108 is attached, and rotationally locked, to the main shaft 104, the eccentric shaft 108 may be caused to move (e.g., rotate) eccentrically about the longitudinal axis 102 of the main shaft 104 as the main shaft 104 rotates concentrically about the longitudinal axis 102 of the main shaft 104.

The terms “multiple-part modular crankshaft,” “multiple-component modular shaft,” “modular shaft assembly,” and “crankshaft” can be used interchangeably herein to refer to the multiple-part modular crankshaft 100 described in accordance with embodiments of the present disclosure.

Features of the multiple-part modular crankshaft 100 may be described in conjunction with a coordinate system 101. The coordinate system 101, as shown in the figures, includes three-dimensions comprising an X-axis, a Y-axis, and a Z-axis. Additionally or alternatively, the coordinate system 101 may be used to define planes (e.g., the XY-plane, the XZ-plane, and the YZ-plane) of the multiple-part modular crankshaft 100. These planes may be disposed orthogonal, or at 90 degrees, to one another. While the origin of the coordinate system 101 may be placed at any point on or near the components of the multiple-part modular crankshaft 100, for the purposes of description, the axes of the coordinate system 101 are always disposed along the same directions from figure to figure. In some examples, reference may be made to dimensions, angles, directions, relative positions, and/or movements associated with one or more components of the multiple-part modular crankshaft 100 with respect to the coordinate system 101. For example, the length of the multiple-part modular crankshaft 100 may be defined as a dimension along the X-axis of the coordinate system 101, the height or first radial dimension of the multiple-part modular crankshaft 100 may be defined as dimension along the Y-axis of the coordinate system 101, and the width or second radial dimension of the multiple-part modular crankshaft 100 may be defined as a dimension along the Z-axis of the coordinate system 101. Additionally or alternatively, the length of the main shaft 104 and/or the eccentric shaft 108 may be defined as a dimension along the X-axis of the coordinate system 101, the height or first radial dimension of the main shaft 104 and/or eccentric shaft 108 may be defined as dimension along the Y-axis of the coordinate system 101, and the width or second radial dimension of the main shaft 104 and/or eccentric shaft 108 may be defined as a dimension along the Z-axis of the coordinate system 101.

The eccentric shaft 108 includes a mating interface 116 that interfaces, or engages, with a modular interconnection interface 112 (e.g., recess, etc.) of the main shaft 104. In one embodiment, the mating interface 116 may be at least partially inserted into a corresponding recess formed in the modular interconnection interface 112 of the main shaft 104 (e.g., forming a protrusion-and-recess interface, etc.). The modular interconnection interface 112 may include a rotational alignment feature 114 that locks the eccentric shaft 108 with the main shaft 104 rotationally (e.g., relative to the longitudinal axis 102). In some embodiments, both the eccentric shaft 108 and the main shaft 104 may include at least one dowel hole (which may define at least a portion of the rotational alignment feature 114). The eccentric shaft 108 may be attached to the main shaft 104 using a fastener 140 inserted into a threaded hole 136 (e.g., formed in the body of the main shaft 104). The fastener 140 may axially affix the eccentric shaft 108 to the main shaft 104. The eccentric shaft 108 may be radially or rotationally locked to the main shaft 104 by way of a torque transmitting component (e.g., locking feature) such as, for example, at least one dowel pin 120 (e.g., shown in the figures as a pair of dowel pins 120A, 120B), which can be inserted into a corresponding dowel hole of the at least one dowel hole of the eccentric shaft 108 and/or the main shaft 104. As described above, a fastener 140 such as, for example, a screw can be inserted through the clearance hole in the eccentric shaft 108 and into the threaded hole 136 of the main shaft 104, or vice versa.

FIG. 1C shows a first section view of the multiple-part modular crankshaft 100 shown in FIG. 1A, taken through a center of the main shaft 104. In particular, FIG. 1C shows a section of the multiple-part modular crankshaft 100 in the direction indicated by arrow “1C” shown in FIG. 1A taken from an XY-plane that passes through the longitudinal axis 102. As illustrated in FIG. 1C, the longitudinal axis 102 may define an axis of rotation for the main shaft 104 and the multiple-part modular crankshaft 100. The eccentric axis 105 may define a central axis for the outer radial surface 150 of the eccentric shaft 108. This eccentric axis 105 may be offset from the longitudinal axis 102 by an offset distance, OD such that the eccentric axis 105 is arranged parallel to and offset from the longitudinal axis 102. Although the longitudinal axis 102 and the eccentric axis 105 extend in an X-axis direction, the eccentric axis 105 is shown offset from the longitudinal axis 102 in the Y-axis direction. As the multiple-part modular crankshaft 100 rotates about the longitudinal axis 102, the outer radial surface 148 of the main shaft 104 remain concentric with the longitudinal axis 102 and the outer radial surface 150 of the eccentric shaft 108 are eccentric with the longitudinal axis 102. This arrangement provides an eccentric rotation of components that are attached to the eccentric shaft 108 relative to components that are attached to the main shaft 104, or vice versa.

FIG. 1D shows a second section view of the multiple-part modular crankshaft 100 shown in FIG. 1A, taken through a center of the main shaft 104. In particular, FIG. 1D shows a section of the multiple-part modular crankshaft 100 in the direction indicated by arrow “1D” shown in FIG. 1A taken from an XZ-plane that passes through the longitudinal axis 102. The section shown in FIG. 1D is arranged 90 degrees relative to the section shown in FIG. 1C, rotated about the X-axis of the coordinate system 101. As illustrated in FIG. 1D, the eccentric shaft 108 is interconnected to the main shaft 104 with a fastener 140, a first dowel pin 120A, and a second dowel pin 120B. The fastener 140 provides a clamping force between the eccentric shaft 108 and the main shaft 104, and the dowel pins 120A, 120B key the eccentric shaft 108 to the main shaft 104 radially. Stated another way, the dowel pins 120A, 120B rotationally lock the eccentric shaft 108 to the main shaft 104. This rotational lock is capable of maintaining the offset distance, OD shown in FIG. 1C during rotation and power transmission of the multiple-part modular crankshaft 100.

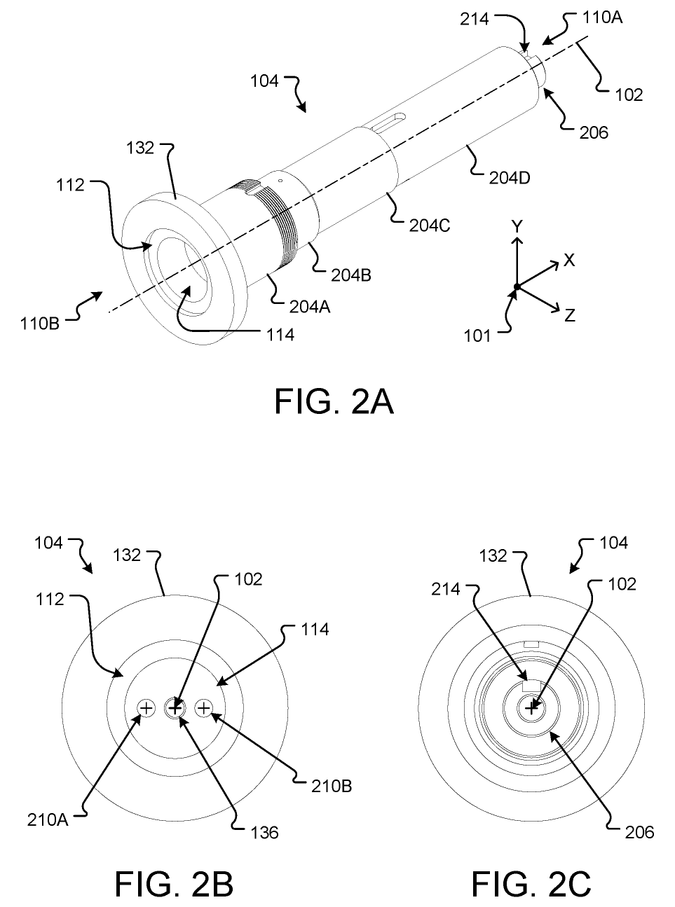

FIGS. 2A-2C provide a more detailed view of the main shaft 104 of the multiple-part modular crankshaft according to at least one embodiment of the present disclosure. The main shaft 104 extends from a first end 110A of the main shaft 104 toward a second end 110B of the main shaft 104. The main shaft 104 may include a flange 132 arranged adjacent or near the second end 110B. The main shaft 104 may also include a plurality of steps 204A-204D extending from the second end 110B toward the first end 110A of the main shaft 104. Each step may be centered around the longitudinal axis 102. In the present embodiment, each step 204A-204D is also configured as a cylindrical shape with a diameter decreasing from a point adjacent the flange 132 toward a nose 206 of the main shaft 104.

A first step 204A of the plurality of steps 204A-204D may include a cylindrical hollow extending from an edge of the modular interconnection interface 112 toward the rotational alignment feature. As shown in FIG. 2B and described above, the rotational alignment feature 114 may include the at least one dowel hole 210A-210B. As illustrated, the least one dowel hole 210A-210B may include a pair of dowel holes 210A-210B arranged on opposite sides of a longitudinal axis 102 of the main shaft 104. For instance, as illustrated in FIG. 2B, a first dowel hole 210A may be arranged on a first side of the longitudinal axis 102 and a second dowel hole 210B may be arranged on a second side of the longitudinal axis 102. In some embodiments, a threaded hole 136 may be arranged between the pair of dowel holes 210A-210B or arranged along an axis that is coincident with the longitudinal axis 102 of the main shaft 104. In some embodiments, the main shaft 104 may include at least one keyway 214. One keyway 214 is shown disposed in the nose 206 shown in FIGS. 2A and 2C. However, additional keyways may be disposed in other portions of the main shaft 104. In any event, each keyway 214 may be configured to receive a key element that is capable of rotationally locking a transmission element (e.g., gear, pulley, scroll, etc.) to the multiple-part modular crankshaft 100.

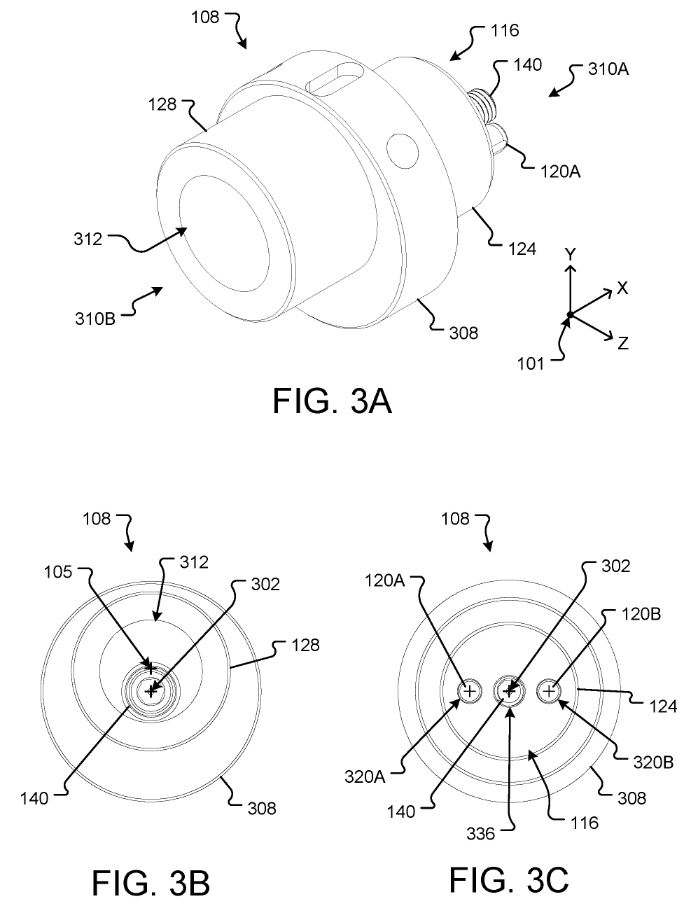

FIGS. 3A-3C illustrate various views of the eccentric shaft 108 of the multiple-part modular crankshaft 100. The eccentric shaft 108 may include a rim 308, a first protrusion 124, or first body, extending from one side of the rim 308, a second protrusion 128, or second body, extending from an opposite side of the rim 308, and a mating interface 116 disposed on the first protrusion 124.

More specifically, the first protrusion 124 extends from the rim 308 toward a first end 310A of the eccentric shaft 108, and the second protrusion 128 extends from the rim 308 toward a second end 310B of the eccentric shaft 108. In the present disclosure, both the first protrusion 124 and the second protrusion 128 are cylindrical in shape. In other embodiments, the first protrusion 124 and/or the second protrusion 128 may be any shape such as, for example, rectangular, oval, oblong, or the like. The second protrusion 128 may include a counterbore 312, or bore, and an eccentric axis 105 extending through a center of the counterbore 312. As illustrated in FIGS. 3A and 3B, the first protrusion 124 and the second protrusion 128 are arranged eccentrically to one another. For instance, the eccentric axis 105 (e.g., the central axis of the second protrusion 128) is shown offset from the longitudinal axis 102 (e.g., the central axis of the first protrusion 124). Among other things, this offset provides an eccentric arrangement between the first protrusion 124 and the second protrusion 128. When the eccentric shaft 108 is attached to the main shaft 104, the first protrusion 124 of the eccentric shaft 108 engages concentrically with the modular interconnection interface 112 of the main shaft 104 and the second protrusion 128 is arranged eccentrically to the first protrusion 124 and the main shaft 104.

At least one embodiment of the eccentric shaft 108 may include one or more dowel pins 120A, 120B. These dowel pins 120A, 120B may be formed from the eccentric shaft 108 or inserted as separate components into corresponding dowel holes 320A, 320B arranged in the eccentric shaft 108 (e.g., in the mating interface 116 of the eccentric shaft 108). Examples of the dowel pins 120A, 120B may include, but are in no way limited to, hardened steel pins, cylindrical pins, tapered pins, diamond pins, and/or combinations thereof. In some embodiments, the eccentric shaft 108 may include a clearance hole 336 through which a fastener 140 may be inserted. For instance, a threaded shaft of a fastener 140 may be inserted through the clearance hole 336 of the eccentric shaft 108 while a head of the fastener 140 may be disposed inside the counterbore 312 of the eccentric shaft 108 (such that the head does not pass through the clearance hole and a portion of the head provides clamping pressure between the eccentric shaft 108 and the main shaft 104 when assembled). The dowel pins 120A, 120B and/or the corresponding dowel holes 320A, 320B are arranged on opposite sides of a longitudinal axis 102 of the eccentric shaft 108. In the present disclosure, the dowel holes 320A, 320B and clearance hole 336 on the eccentric shaft 108 and the dowel holes 210A, 210B and threaded hole 136 on the main shaft 104 are arranged to receive the at least one dowel pin 120A, 120B and the fastener 140, respectively. Thus, the eccentric shaft 108 can be attached to the main shaft 104 by inserting two dowel pins 120A, 120B and a screw or fastener 140 through the eccentric shaft 108 and into engagement with the main shaft 104. Once attached, the eccentric shaft 108 is axially and radially (e.g., rotationally) locked relative to the main shaft 104.

When connected to the main shaft 104, the longitudinal axis 302 of the eccentric shaft 108 is arranged coincident with, or along the same line as (e.g., overlapping), the longitudinal axis 102 of the main shaft 104, while the eccentric axis 105 of the eccentric shaft 108 is arranged parallel to and offset a distance (e.g., offset distance, OD) from the longitudinal axis 102 of the main shaft 104 and the longitudinal axis 302 eccentric shaft 108. Consequently, when engaging the eccentric shaft 108 with the main shaft 104, the two shafts 104, 108 include a longitudinal axis 102, 302 arranged coincident with one another in a line. The eccentric shaft 108, which includes the eccentric axis 105, is arranged parallel to and offset from the longitudinal axis 102 and is configured to rotate, in a rotationally fixed arrangement with the crankshaft, around the longitudinal axis 102.

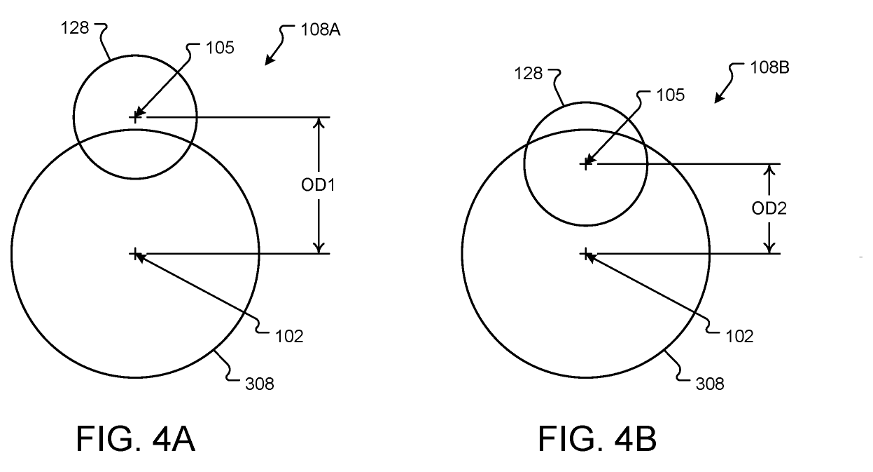

FIGS. 4A and 4B illustrate schematic diagrams of two eccentric shafts 108A, 108B with different offset distances, ODs in accordance with embodiments of the present disclosure. The first eccentric shaft 108A, shown in FIG. 4A, includes a first offset distance, OD1 and a second eccentric shaft 108B, shown in FIG. 4B, includes a second offset distance, OD2. The first offset distance, OD1 is greater than the second offset distance, OD2 providing a greater eccentricity for the first eccentric shaft 108A than the second eccentric shaft 108B.

At least one aspect of the present disclosure is that a single main shaft 104 in the crankshaft may be compatible with different eccentric shafts 108A, 108B, for example, having different offset distances, ODs or eccentricities. For example, when it is desirable to switch the eccentric offset distance from the first offset distance, OD1 to the second offset distance, OD2 (e.g., to alter an eccentricity, fit, or function of a scroll device, etc.), the eccentric shaft 108A with the first offset distance, OD1 can be disassembled from the main shaft 104 and replaced with the eccentric shaft 108B with second offset distance, OD2 through the aforementioned connecting component (e.g., a screw or a fastener 140) and one or more torque transmitting, or rotationally locking, component (e.g., a pair of dowel pins 120 or other locking feature). Among other things, this replacement process avoids the requirement of disassembling the entire scroll device and/or using multiple one-piece crankshafts in conventional approaches when a change to eccentricity is desired or needed. When in an operating stage, the eccentric shafts 108A, 108B with different offset distances, ODs will rotate along the longitudinal axis 102 of the main shaft 104, but with different, pre-configured offset distances, ODs or eccentricities.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges, or steps to those claimed, whether or not such alternate, interchangeable and/or equivalent structures, functions, ranges or steps are disclosed herein, and without intending to publicly dedicate any patentable subject matter.

Exemplary aspects are directed to a multiple-part modular shaft, comprising: a main shaft extending a length from a first end of the main shaft to a second end of the main shaft, wherein the main shaft further comprises: a longitudinal axis extending along the length and defining a rotational center of the main shaft; and a modular interconnection interface arranged at the second end of the main shaft, the modular interconnection interface comprising a rotational alignment feature that is rotationally fixed relative to the longitudinal axis; and an eccentric shaft comprising a first body portion arranged at a first end of the eccentric shaft and a second body portion arranged at a second end of the eccentric shaft, wherein the first body portion is connected to the second body portion, wherein the second body portion is eccentrically offset from the first body portion by a first offset distance, and wherein the eccentric shaft further comprises: a mating interface arranged at the first end of the eccentric shaft, the mating interface comprising a locking feature (e.g., a torque transmitting component, etc.) that operatively connects with the rotational alignment feature of the modular interconnection interface of the main shaft and rotationally fixes the eccentric shaft to the main shaft relative to the longitudinal axis when the eccentric shaft is attached to the main shaft.

Any one or more of the above aspects include wherein the modular interconnection interface comprises a recessed portion disposed in the second end of the main shaft, and wherein the mating interface comprises a protrusion that is received by the recessed portion of the modular interconnection interface in an assembled state. Any one or more of the above aspects include wherein the rotational alignment feature comprises: a first dowel hole extending into the main shaft in a direction toward the first end of the main shaft, the first dowel hole arranged on a first side of the longitudinal axis; and a second dowel hole extending into the main shaft in the direction toward the first end of the main shaft, the second dowel hole arranged on a second side of the longitudinal axis opposite the first side of the longitudinal axis. Any one or more of the above aspects include wherein the locking feature comprises: a first dowel pin disposed in the first dowel hole in the assembled state; and a second dowel pin disposed in the second dowel hole in the assembled state. Any one or more of the above aspects include wherein at least one of the first dowel pin and the second dowel pin is a diamond pin. Any one or more of the above aspects include wherein the rotational alignment feature and the locking feature comprise a protrusion-and-recess interface and a doweled interconnection. Any one or more of the above aspects include wherein the main shaft comprises a threaded hole extending into the main shaft in a direction from the second end toward the first end. Any one or more of the above aspects include wherein the threaded hole is centered on the longitudinal axis. Any one or more of the above aspects include wherein the multiple-part modular shaft further comprises a fastener axially attaching the eccentric shaft to the main shaft. Any one or more of the above aspects include wherein the eccentric shaft is selectively removable from the main shaft by removal of the fastener from the multiple-part modular shaft.

Exemplary aspects are directed to a modular shaft assembly, comprising: a main shaft extending a length from a first end of the main shaft to a second end of the main shaft, wherein the main shaft further comprises: a longitudinal axis extending along the length and defining a rotational center of the main shaft; and a modular interconnection interface arranged at the second end of the main shaft, the modular interconnection interface comprising a rotational alignment feature that is rotationally fixed relative to the longitudinal axis, wherein the modular interconnection interface engages with an eccentric shaft selected from a plurality of eccentric shafts, wherein each eccentric shaft of the plurality of eccentric shafts comprises: a first body portion arranged at a first end of the eccentric shaft; and a second body portion arranged at a second end of the eccentric shaft, wherein the second body portion is eccentrically attached to the first body portion by an eccentric offset distance, and wherein the eccentric offset distance defines an eccentricity of the eccentric shaft relative to the longitudinal axis.

Any one or more of the above aspects include wherein the plurality of eccentric shafts comprises: a first eccentric shaft comprising a first eccentric offset distance; and a second eccentric shaft comprising a second eccentric offset distance that is different from the first eccentric offset distance. Any one or more of the above aspects include wherein the first eccentric offset distance defines a first eccentricity of the modular shaft assembly, wherein the second eccentric offset distance defines a second eccentricity of the modular shaft assembly, and wherein the first eccentric offset distance is greater than the second eccentric offset distance. Any one or more of the above aspects include wherein each eccentric shaft further comprises: a mating interface arranged at the first end of the eccentric shaft, the mating interface comprising a torque transmitting component that operatively connects with the rotational alignment feature of the modular interconnection interface of the main shaft and rotationally fixes the eccentric shaft to the main shaft relative to the longitudinal axis when the eccentric shaft is attached to the main shaft in an assembled state. Any one or more of the above aspects include wherein, in the assembled state, the second end of the eccentric shaft comprises an outer circumferential surface that is eccentrically offset from the longitudinal axis by a first offset distance. Any one or more of the above aspects include wherein the eccentric shaft is axially affixed to the main shaft via a fastener clamping the eccentric shaft to the main shaft, and wherein the eccentric shaft is rotationally locked to the main shaft via at least one dowel pin engaged with the eccentric shaft and the main shaft.

Exemplary aspects are directed to crankshaft, comprising: a main shaft extending a first length along a first longitudinal axis from a first end of the main shaft to a second end of the main shaft, wherein the first end is arranged opposite the second end; and an eccentric shaft that extends a second length along a second longitudinal axis from a first end of the eccentric shaft to a second end of the eccentric shaft, wherein the eccentric shaft further comprises: a rim centered with the second longitudinal axis of the eccentric shaft; a first protrusion extending from the rim in a direction toward the first end of the eccentric shaft, wherein the first protrusion is concentric with the rim; and a second protrusion extending from the rim in a direction along an eccentric axis toward the second end of the eccentric shaft, wherein the eccentric axis is arranged parallel to and offset a distance from the second longitudinal axis, and wherein the second protrusion is arranged eccentric to the first protrusion; wherein the eccentric shaft is selectively attached to the main shaft at an interface between the first protrusion and the second end of the main shaft, and wherein the eccentric shaft is rotationally fixed at a first eccentricity relative to the main shaft via a torque transmitting component of the interface.

Any one or more of the above aspects include wherein a fastener connects the eccentric shaft to the main shaft. Any one or more of the above aspects include wherein the torque transmitting component is at least one dowel pin. Any one or more of the above aspects include wherein the main shaft further comprises: a flange extending a second length from the second end of the main shaft to the first end of the main shaft, wherein the second length is shorter than the first length; and an outer radial surface comprising a plurality of steps that each decrease in diameter from the flange to the first end.

Exemplary aspects are directed to a system for replacing an eccentric offset distance of a crankshaft, comprising: a main shaft with a longitudinal axis further comprising a modular interconnection interface; and a plurality of eccentric shafts operable to be selectively secured to the main shaft, each eccentric shaft of the plurality of eccentric shafts comprising: a first body; a mating interface; and a pre-configured offset distance defined by an eccentric axis and a centerline of each eccentric shaft.

Any one or more of the above aspects include wherein the modular interconnection interface comprises a rotational alignment feature that is rotationally fixed to the longitudinal axis. Any one or more of the above aspects further comprising: a tool set configured to apply a force to each eccentric shaft of the plurality of eccentric shafts during insertion and mating of the first body of each eccentric shaft to the main shaft via the mating interface and the modular interconnection interface. Any one or more of the above aspects wherein the tool set further comprises a connecting component and a torque transmittal component.

Any one or more of the above aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The exemplary systems and methods of this disclosure have been described in relation to shafts for scroll devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in conjunction with one embodiment, it is submitted that the description of such feature, structure, or characteristic may apply to any other embodiment unless so stated and/or except as will be readily apparent to one skilled in the art from the description. The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

What is claimed is:

1. A multiple-part modular shaft, comprising:
a main shaft extending a length from a first end of the main shaft to a second end of the main shaft, wherein the main shaft further comprises:
a longitudinal axis extending along the length and defining a rotational center of the main shaft; and
a modular interconnection interface arranged at the second end of the main shaft, the modular interconnection interface comprising a rotational alignment feature that is rotationally fixed relative to the longitudinal axis; and
an eccentric shaft comprising a first body portion arranged at a first end of the eccentric shaft and a second body portion arranged at a second end of the eccentric shaft, wherein the first body portion is connected to the second body portion, wherein the second body portion is eccentrically offset from the first body portion by a first offset distance, and wherein the eccentric shaft further comprises:
a mating interface arranged at the first end of the eccentric shaft, the mating interface comprising a locking feature that operatively connects with the rotational alignment feature of the modular interconnection interface of the main shaft and rotationally fixes the eccentric shaft to the main shaft relative to the longitudinal axis when the eccentric shaft is attached to the main shaft.

2. The multiple-part modular shaft of claim 1, wherein the modular interconnection interface comprises a recessed portion disposed in the second end of the main shaft, and wherein the mating interface comprises a protrusion that is received by the recessed portion of the modular interconnection interface in an assembled state.

3. The multiple-part modular shaft of claim 2, wherein the rotational alignment feature comprises:
a first dowel hole extending into the main shaft in a direction toward the first end of the main shaft, the first dowel hole arranged on a first side of the longitudinal axis; and
a second dowel hole extending into the main shaft in the direction toward the first end of the main shaft, the second dowel hole arranged on a second side of the longitudinal axis opposite the first side of the longitudinal axis.

4. The multiple-part modular shaft of claim 3, wherein the locking feature comprises:
a first dowel pin disposed in the first dowel hole in the assembled state; and
a second dowel pin disposed in the second dowel hole in the assembled state.

5. The multiple-part modular shaft of claim 4, wherein at least one of the first dowel pin and the second dowel pin is a diamond pin.

6. The multiple-part modular shaft of claim 1, wherein the rotational alignment feature and the locking feature comprise a protrusion-and-recess interface and a doweled interconnection.

7. The multiple-part modular shaft of claim 1, wherein the main shaft comprises a threaded hole extending into the main shaft in a direction from the second end toward the first end.

8. The multiple-part modular shaft of claim 7, wherein the threaded hole is centered on the longitudinal axis.

9. The multiple-part modular shaft of claim 8, wherein the multiple-part modular shaft further comprises a fastener axially attaching the eccentric shaft to the main shaft.

10. The multiple-part modular shaft of claim 9, wherein the eccentric shaft is selectively removable from the main shaft by removal of the fastener from the multiple-part modular shaft.

11. A modular shaft assembly, comprising:
a main shaft extending a length from a first end of the main shaft to a second end of the main shaft, wherein the main shaft further comprises:
a longitudinal axis extending along the length and defining a rotational center of the main shaft; and
a modular interconnection interface arranged at the second end of the main shaft, the modular interconnection interface comprising a rotational alignment feature that is rotationally fixed relative to the longitudinal axis, wherein the modular interconnection interface engages with an eccentric shaft selected from a plurality of eccentric shafts, wherein each eccentric shaft of the plurality of eccentric shafts comprises:
a first body portion arranged at a first end of the eccentric shaft; and
a second body portion arranged at a second end of the eccentric shaft, wherein the second body portion is eccentrically attached to the first body portion by an eccentric offset distance, and wherein the eccentric offset distance defines an eccentricity of the eccentric shaft relative to the longitudinal axis.

12. The modular shaft assembly of claim 11, wherein the plurality of eccentric shafts comprises:
a first eccentric shaft comprising a first eccentric offset distance; and
a second eccentric shaft comprising a second eccentric offset distance that is different from the first eccentric offset distance.

13. The modular shaft assembly of claim 12, wherein the first eccentric offset distance defines a first eccentricity of the modular shaft assembly, wherein the second eccentric offset distance defines a second eccentricity of the modular shaft assembly, and wherein the first eccentric offset distance is greater than the second eccentric offset distance.

14. The modular shaft assembly of claim 11, wherein each eccentric shaft further comprises:
a mating interface arranged at the first end of the eccentric shaft, the mating interface comprising a torque transmitting component that operatively connects with the rotational alignment feature of the modular interconnection interface of the main shaft and rotationally fixes the eccentric shaft to the main shaft relative to the longitudinal axis when the eccentric shaft is attached to the main shaft in an assembled state.

15. The modular shaft assembly of claim 14, wherein, in the assembled state, the second end of the eccentric shaft comprises an outer circumferential surface that is eccentrically offset from the longitudinal axis by a first offset distance.

16. The modular shaft assembly of claim 14, wherein the eccentric shaft is axially affixed to the main shaft via a fastener clamping the eccentric shaft to the main shaft, and wherein the eccentric shaft is rotationally locked to the main shaft via at least one dowel pin engaged with the eccentric shaft and the main shaft.

17. A crankshaft, comprising:
a main shaft extending a first length along a first longitudinal axis from a first end of the main shaft to a second end of the main shaft, wherein the first end is arranged opposite the second end; and
an eccentric shaft that extends a second length along a second longitudinal axis from a first end of the eccentric shaft to a second end of the eccentric shaft, wherein the eccentric shaft further comprises:
a rim centered with the second longitudinal axis of the eccentric shaft;
a first protrusion extending from the rim in a direction toward the first end of the eccentric shaft, wherein the first protrusion is concentric with the rim; and
a second protrusion extending from the rim in a direction along an eccentric axis toward the second end of the eccentric shaft, wherein the eccentric axis is arranged parallel to and offset a distance from the second longitudinal axis, and wherein the second protrusion is arranged eccentric to the first protrusion;
wherein the eccentric shaft is selectively attached to the main shaft at an interface between the first protrusion and the second end of the main shaft, and wherein the eccentric shaft is rotationally fixed at a first eccentricity relative to the main shaft via a torque transmitting component of the interface.

18. The crankshaft of claim 17, wherein a fastener connects the eccentric shaft to the main shaft.

19. The crankshaft of claim 17, wherein the torque transmitting component is at least one dowel pin.

20. The crankshaft of claim 17, wherein the main shaft further comprises:
a flange extending a second length from the second end of the main shaft to the first end of the main shaft, wherein the second length is shorter than the first length; and
an outer radial surface comprising a plurality of steps that each decrease in diameter from the flange to the first end.
